(19) United States
(12) Patent Application Publication
(10) Pub. No.: US 2023/0367899 A1
(43) Pub. Date: Nov. 16, 2023

(54) SYSTEM AND METHOD FOR DATA PRIVACY CONTROL

(71) Applicant: David Franklin Hanson, JR., Richardson, TX (US)

(72) Inventor: David Franklin Hanson, JR., Richardson, TX (US)

(21) Appl. No.: 17/741,500

(22) Filed: May 11, 2022

(51) Int. Cl. G06F 21/62; G06F 16/14; H04L 9/00

(52) U.S. Cl. CPC G06F 21/6245; G06F 16/152; H04L 9/50; H04L 2209/56

(57) ABSTRACT

A system for data privacy control is disclosed. The system may generate a plurality of assets associated with a plurality of privacy settings. The plurality of privacy settings are associated with a permission of usage of user data of a user for an electronic device associated with the user. The system may provide a set of selections associated with each asset to a user, by use of the electronic device. Each selection of the set of selections may correspond to one of acceptance of the privacy setting, rejection of the privacy setting or modification of the privacy setting. The system may receive one or more inputs from the user based on the set of selections provided to the user. The system may further modify one or more privacy settings of the plurality of privacy settings based on the received one or more inputs from the user.

### TECHNICAL FIELD

This disclosure relates generally to data privacy control, and more particularly to system and method of data privacy control by use of blockchain technology.

### BACKGROUND

With rapid advancements in technology, sensor-based systems have become prevalent in lives of humans. For example, the sensor-based systems such as internet-of-things (IoT), Augmented Reality (AR), Virtual Reality (VR), home automation systems, robotic systems and imaging systems such as drones are commonly utilized for various applications. Such systems may focus on providing a user-immersive and personalized experience for users. To provide such experience, the systems may utilize sensors to record user data. For example, the sensors may record images and audio associated with the user. The sensors may further collect information such as personal information, health records, location information and the like.

Moreover, with increase in usage of the sensor-based systems, data privacy concerns have also risen. The collected user data needs to be securely collected and utilized such that a malicious entity is unable to misuse the user data. For example, a data breach may lead to misuse of the personal information of the user. As the sensor-based systems have become an essential part of everyday life of humans, it may be difficult for the user to realize the data that is being collected by such systems. The users may be unaware of a type of data and an amount of data associated with the user that may be collected by the sensor-based systems. Furthermore, the users may be unaware of the user data shared with a third-party, such as cloud-based platforms by the sensor-based systems. Thus, the conventional systems may fail to provide a control over the privacy of the user data.

### SUMMARY

In one embodiment, a system of data privacy control is disclosed. The system may include a processor and a memory communicatively coupled to the processor. The memory may store a plurality of processor-executable instructions which upon execution by the processor may cause the processor to generate a plurality of assets associated with a plurality of privacy settings. Each asset may include at least a metadata hash value of the privacy setting and a web address of a cloud-based service. The plurality of privacy settings may be associated with a permission of usage of user data of a user for an electronic device associated with the user. The processor may further provide a set of selections associated with each asset to a user, by use of the electronic device. Each selection of the set of selections may correspond to one of acceptance of the privacy setting, rejection of the privacy setting or modification of the privacy setting. The processor may further receive one or more inputs from the user based on the set of selections provided to the user. The processor may further modify one or more privacy settings of the plurality of privacy settings based on the received one or more inputs from the user.

In another embodiment, a method of data privacy control is disclosed. The method may include generating a plurality of assets associated with a plurality of privacy settings. Each asset may include at least a metadata hash value of the privacy setting and a web address of a cloud-based service. The plurality of privacy settings may be associated with a permission of usage of user data of a user for an electronic device associated with the user. The method may further include providing a set of selections associated with each asset to a user, by use of the electronic device. Each selection of the set of selections may correspond to one of acceptance of the privacy setting, rejection of the privacy setting or modification of the privacy setting. The method may further include receiving one or more inputs from the user based on the set of selections provided to the user. The method may further include modifying one or more privacy settings of the plurality of privacy settings based on the received one or more inputs from the user.

In yet another embodiment, a non-transitory computer-readable medium storing computer-executable instructions for performing interaction is disclosed. The computer-executable instructions may be configured for generating a plurality of assets associated with a plurality of privacy settings. Each asset may include at least a metadata hash value of the privacy setting and a web address of a cloud-based service. The plurality of privacy settings may be associated with a permission of usage of user data of a user for an electronic device associated with the user. The computer-executable instructions may be further configured for providing a set of selections associated with each asset to a user, by use of the electronic device. Each selection of the set of selections may correspond to one of acceptance of the privacy setting, rejection of the privacy setting or modification of the privacy setting. The computer-executable instructions may be further configured for receiving one or more inputs from the user based on the set of selections provided to the user. The computer-executable instructions may be further configured for modifying one or more privacy settings of the plurality of privacy settings based on the received one or more inputs from the user.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of a system for data privacy control, in accordance with an embodiment.

FIG. 2 is a block diagram of an exemplary system for implementing various embodiments.

FIG. 3 is a block diagram representing steps performed for data privacy control by the system, in accordance with an embodiment.

FIG. 4A is a first user interface (UI) that depicts a blockchain user account, in accordance with an embodiment.

FIG. 4B is a second UI that depicts general information of an asset, in accordance with an embodiment.

FIG. 4C is a third UI that depicts technical information of the asset, in accordance with an embodiment.

FIG. 5 is a flowchart illustrating a method of data privacy control, in accordance with an embodiment.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

One or more techniques are disclosed that seek to provide a solution to the above-mentioned challenges faced by the technologies of the prior art, by utilizing a blockchain network and a cryptographic key pair for data privacy control. The system may generate a blockchain user account associated with a user. Further, the system may generate a plurality of assets (also referred as tokens) and store the plurality of assets on the blockchain user account. For example, the plurality of assets may be generated based on a permission of usage of the user data granted by the user. Thus, each asset of the plurality of assets is generated after permission may be granted by the user.

Moreover, the blockchain user account may be accessed by the user to check the plurality of assets present in the blockchain user account. The presence of the asset in the blockchain user account may depict that the permission related to a privacy setting of the present asset may be granted by the user. The system may enable deletion of one or more assets of the plurality of assets, based on a preference of the user. For example, a first asset of the plurality of assets may be deleted from the blockchain user account by the user when the user may no longer require the permission to be granted to the privacy setting associated with the first asset. Furthermore, a web address of a cloud-based service may be verified by the system, before transmission of any user data on the web address. Such verification may ensure that the user data may not be shared with any third-party without a consent of the user. Thus, the techniques of the present disclosure are based on the blockchain network and the cryptographic key pair may be utilized for the data privacy control which are later discussed in this disclosure.

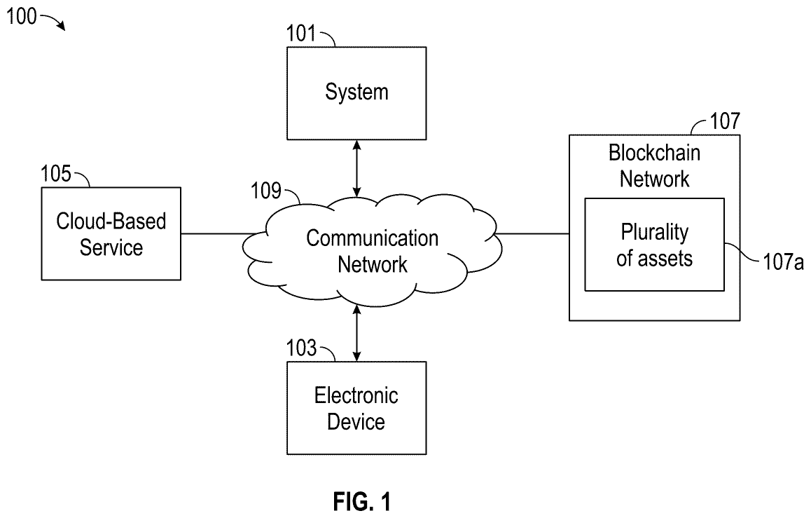

In one embodiment, a block diagram 100 of a system 101 for data privacy control is illustrated in FIG. 1, in accordance with an embodiment. The block diagram 100 may include the system 101, an electronic device 103, a cloud-based service 105, a blockchain network 107 and a communication network 109.

The system 101 may include suitable logic, code, or circuitry that may enable the system 101 to perform operations for the data privacy control. For example, the system 101 may be configured to generate a plurality of assets associated with a plurality of privacy settings. The system 101 may receive selection of one or inputs associated with the plurality of privacy settings, based on which the system 101 may modify one or more privacy settings of the plurality of privacy settings for the data privacy control. In an example embodiment, the system 101 may be embodied in one or more of several ways as per the required implementation. For example, the system 101 may be embodied as a cloud-based service, a cloud based application, a remote server based service, a remote server based application, a virtual computing system, a remote server platform or a cloud based platform. Examples of the system 101 may include, but are not limited to an internet-of-things (IoT) device, an augmented reality (AR) device, a virtual reality (VR) device, a mixed reality device, a gaming device, an infotainment device, a desktop, a laptop, a notebook, a netbook, a tablet, a smartphone, a mobile phone, an application server, a web server, or the like.

The electronic device 103 may be a sensor-based computing device having data processing capability. In some instances, the electronic device 103 may have capability for performing interaction with a human, a robot, a computing device, ora virtual character. Examples of the electronic device 103 may include, but are not limited to the IoT device, the AR device, the VR device, the mixed reality device, the gaming device, the infotainment device, the desktop, the laptop, the notebook, the netbook, the tablet, the smartphone, the mobile phone, the application server, the web server, or the like. It may be noted that, in some embodiments, the system 101 may be embodied with the electronic device 103, without departing from the scope of the disclosure.

In some embodiments, the electronic device 103 may further include one or more sensors. The one or more sensors may be configured to obtain user data (or sensor data) associated with a user, for usage of the electronic device 103. Examples of the or more sensors may include, but are not limited to an image sensor, an audio sensor, a location sensor, a proximity sensor, a light sensor, a temperature sensor and an acceleration sensor.

The cloud-based service 105 may provide a platform to the user for utilizing various applications of the electronic device 103. The cloud-based service 105 may be implemented at a backend of the system 101. For example, the cloud-based service 105 may be utilized to access online features of the electronic device 103 by the user. The cloud-based service 105 may further be utilized for datastore management. The electronic device 103 may utilize the cloud-based service 105 by use of internet service.

The blockchain network 107 may be a distributed database that may include a plurality of nodes. Each node of the plurality of nodes may be associated with an entity such as an individual user or an enterprise. The blockchain network 107 may be utilized to securely store the user data associated with the user. The blockchain network 107 may further include a plurality of assets 107a. The system 101 may be configured to generate the plurality of assets 107a associated with a plurality of privacy settings. The plurality of privacy settings may be associated with a permission of usage of the user data of the user for the electronic device 103 associated with the user. The plurality of assets 107a may be stored on the blockchain network 107. Examples of the blockchain network 107 may include, but are not limited to, algorand blockchain, ethereum blockchain, Hyperledger blockchain and ripple blockchain. For example, the plurality of assets 107a may be algorand standard assets (ASAs).

The system 101, the electronic device 103, the cloud-based service 105 and the blockchain network 107 may be communicatively coupled with each other via the communication network 109. The communication network 109 may be a wired or a wireless network and the examples may include, but are not limited to the Internet, Wireless Local Area Network (WLAN), Wi-Fi, Long Term Evolution (LTE), Worldwide Interoperability for Microwave Access (WiMAX), and General Packet Radio Service (GPRS).

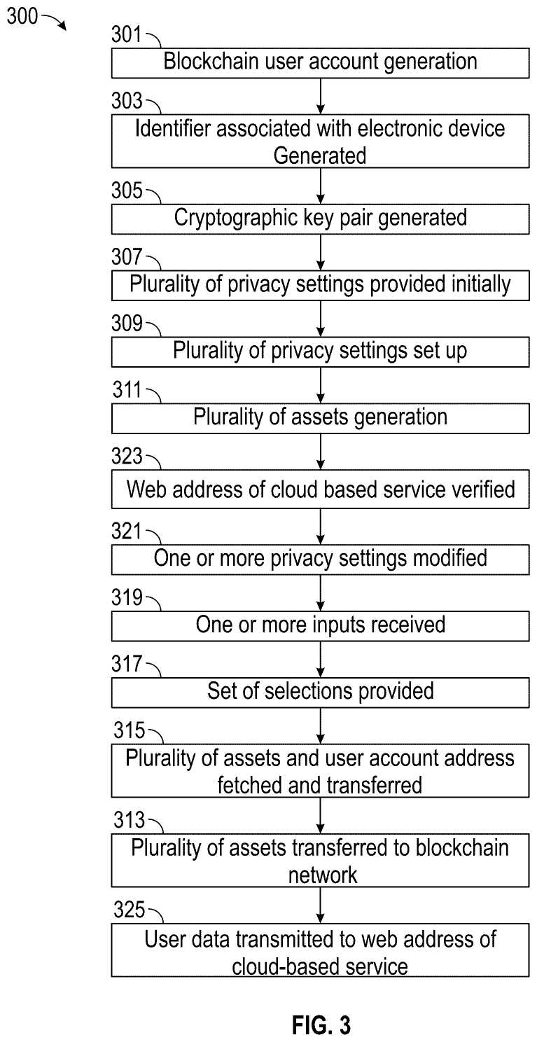

In operation, the system 101 may be configured to generate the plurality of assets 107a associated with the plurality of privacy settings. Each asset may include at least a metadata hash value of the privacy setting and a web address of a cloud-based service. In an embodiment, the plurality of assets 107a may be generated based on the plurality of privacy settings initially accepted by the user. Details of the generation of the plurality of assets 107a are further described, for example, in FIG. 3.

The system 101 may be further configured to provide a set of selections associated with each asset to the user, by use of the electronic device 103. For example, the system 101 may display the set of selections on the electronic device 103 for the user. In another example, the system 101 may provide the set of selections in form of an audio output. Each selection of the set of selections may correspond to one of an acceptance of the privacy setting, a rejection of the privacy setting or modification of the privacy setting. Details of providing the set of selections are further described, for example, in FIG. 3.

The system 101 may be further configured to receive one or more inputs from the user based on the set of selections provided to the user. For example, a first asset of the plurality of assets 107a may correspond to a privacy setting of a location. A first input may correspond to rejection of the privacy setting of the location associated with the first asset. Details of the reception of the one or more inputs are further described, for example, in FIG. 3.

The system 101 may be further configured to modify one or more privacy settings of the plurality of privacy settings based on the received one or more inputs from the user. For example, the privacy setting of the location may be modified and set as permission denied, based on the received first input by the user. In such a case, the electronic device 103 may stop recording of the location of the user. Details of the modification of the one or more privacy settings of the plurality of privacy settings are further described, for example, in FIG. 3.

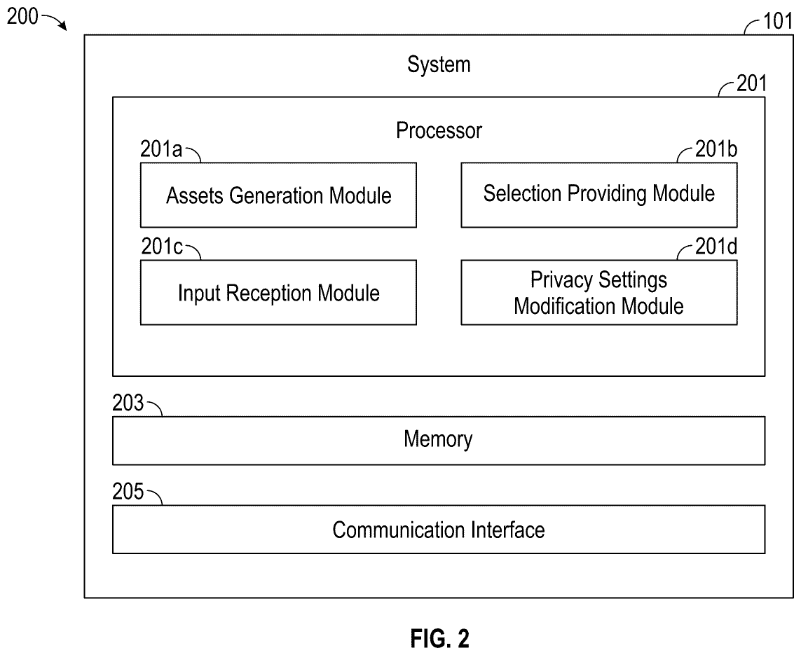

FIG. 2 is a block diagram 200 of an exemplary system for implementing various embodiments. FIG. 2 is explained in conjunction with elements of FIG. 1. The block diagram 200 may include the system 101. The system 101 may include a processor 201, a memory 203 and a communication interface 205. The processor 201 may further include an asset generation module 201a, a selection providing module 201b, an input reception module 201c and a privacy settings modification module 201d.

The processor 201 may be embodied in a number of different ways. For example, the processor 201 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 201 may include one or more processing cores configured to perform independently. A multi-core processor may enable multiprocessing within a single physical package. Additionally, or alternatively, the processor 201 may include one or more processors configured in tandem via the bus to enable independent execution of instructions, pipelining and/or multithreading.

In some embodiments, the asset generation module 201a may be configured to generate the plurality of assets 107a. The selection providing module 201b may provide the set of selections associated with each asset to the user. Based on the set of selections provided to the user, the input reception module 201c may receive the one or more inputs from the user. Furthermore, based on the received one or more inputs from the user, the privacy settings modification module 201d may modify the one or more privacy settings of the plurality of privacy settings.

Additionally, or alternatively, the processor 201 may include one or more processors capable of processing large volumes of workloads and operations to data privacy control. In an example embodiment, the processor 201 may be in communication with the memory 203 via a bus for passing information among components coupled to the system 101.

The memory 203 may be non-transitory and may include, for example, one or more volatile and/or non-volatile memories. In other words, for example, the memory 203 may be an electronic storage device (for example, a computer readable storage medium) comprising gates configured to store data (for example, bits) that may be retrievable by a machine (for example, a computing device like the processor 201). The memory 203 may be configured to store information, data, content, applications, instructions, or the like, for enabling the apparatus to carry out various functions in accordance with an example embodiment of the present invention. For example, the memory 203 may be configured to buffer input data for processing by the processor 201. As exemplarily illustrated in FIG. 2, the memory 203 may be communicatively coupled to the processor 201 and may be configured to store a plurality of processor-executable instructions for execution by the processor 201. As such, whether configured by hardware or software methods, or by a combination thereof, the processor 201 may represent an entity (for example, physically embodied in circuitry) capable of performing operations according to an embodiment of the present invention while configured accordingly. Thus, for example, when the processor 201 is embodied as an ASIC, FPGA or the like, the processor 201 may be specifically configured hardware for conducting the operations described herein. Alternatively, as another example, when the processor 201 is embodied as an executor of software instructions, the instructions may specifically configure the processor 201 to perform the algorithms and/or operations described herein when the instructions are executed. However, in some cases, the processor 201 may be a processor specific device (for example, a mobile terminal or a fixed computing device) configured to employ an embodiment of the present invention by further configuration of the processor 201 by instructions for performing the algorithms and/or operations described herein. The processor 201 may include, among other things, a clock, an arithmetic logic unit (ALU) and logic gates configured to support operation of the processor 201.

The communication interface 205 may comprise input interface and output interface for supporting communications to and from the system 101 or any other component with which the system 101 may communicate. The communication interface 205 may be any means such as a device or circuitry embodied in either hardware or a combination of hardware and software that is configured to receive and/or transmit data to/from a communications device in communication with the system 101. In this regard, the communication interface 205 may include, for example, an antenna (or multiple antennae) and supporting hardware and/or software for enabling communications with a wireless communication network. Additionally, or alternatively, the communication interface 205 may include the circuitry for interacting with the antenna(s) to cause transmission of signals via the antenna(s) or to handle receipt of signals received via the antenna(s). In some environments, the communication interface 205 may alternatively or additionally support wired communication. As such, for example, the communication interface 205 may include a communication modem and/or other hardware and/or software for supporting communication via cable, digital subscriber line (DSL), universal serial bus (USB) or other mechanisms.

FIG. 3 is a block diagram 300 representing steps performed for data privacy control by the system, in accordance with an embodiment. FIG. 3 is explained in conjunction with elements of FIGS. 1 and 2. The block diagram 300 may include steps 301 to 325. The processor 201 may be configured to perform the steps depicted in the block diagram 300 for data privacy control.

The processor 201 may utilize the blockchain network 107 and a cryptographic key pair to securely store and utilize the user data for various requirements of the electronic device 103. In an exemplary scenario, the electronic device 103 may be an interaction robot that may be utilized for different applications by the user. For example, the interaction robot may be utilized by the user (such as a child) as an infotainment device to learn coding in an entertaining manner. In such a case, the interaction robot may be present at a home of the user. Thus, the user data recorded by the interaction robot may need to be monitored by the user (such as a parent of the child). The processor 201 may provide a process for data privacy control for the user such that the user may be able to easily check the data being recorded by the interaction robot at any time and may reject or accept any privacy setting as per the requirement of the user. The usage of the blockchain network 107 and the cryptographic key pair for data privacy control is further described from steps 301 to 325.

At 301, the processor 201 may perform an initialization process. As part of the initialization process, the blockchain user account may be generated. In accordance with an embodiment, the processor 201 may be configured to generate the blockchain user account associated with the user. The blockchain user account may be generated on the blockchain network 107. The generated blockchain user account may be associated with a user account address. The blockchain user account may have the user account address associated therewith that may be unique to the user. The blockchain network 107 may be utilized to manage and store the user data securely. During a setup of the electronic device 103, the processor 201 may provide steps to the user to assist in the generation of the blockchain user account. The processor 201 may utilize user information such as, name of the user and an electronic mail (ID) to generate the blockchain user account. In some embodiments, the processor 201 may utilize an application programming interface (API) to communicate with the blockchain network 107.

At 303, an identifier associated with the electronic device 103 may be generated. In accordance with an embodiment, the processor 201 may be configured to generate the identifier associated with the electronic device 103. The processor 201 may generate the identifier as part of the initialization process. The processor 201 may generate the identifier to link the electronic device 103 with the generated blockchain user account of the user. Thus, the identity of the electronic device 103 may be verified by use of the generated identifier.

At 305, the cryptographic key pair may be generated. In accordance with an embodiment, the generated blockchain user account may be associated with the cryptographic key pair. The processor 201 may generate the cryptographic key pair as part of the initialization process. The processor 201 may further generate a blockchain wallet linked to the blockchain user account. The generation of the blockchain wallet may result in the generation of the cryptographic key pair. For example, the processor 201 may utilize the blockchain wallet and the user account address of the blockchain user account to generate the cryptographic key pair.

In accordance with an embodiment, the processor 201 may be configured to generate the cryptographic key pair associated with the blockchain user account, based on the generated identifier associated with the electronic device 103. The generated identifier may be utilized to generate the cryptographic key pair such that the cryptographic key may be unique to the registered electronic device 103 and the linked blockchain user account. The generated identifier may be a private identifier that may only be used as a seed to generate the cryptographic key pair based on the user account address.

In accordance with an embodiment, the cryptographic key pair may include a public key and a private key. The public key and the private key may be associated with the generated blockchain wallet. The public key and the private key (such as a secret mnemonic key) may be provided to the user for use. The public key may be stored in the memory 203 of the system 101 and the electronic device 103. In some cases, the system 101 may be a part of the electronic device 103, thus, the public key may be stored in the memory 203. The public key may be shared for sharing the user data between the electronic device 103 and the cloud-based service 105. The private key may be transmitted to the electronic device 103 associated with the user. The private key may be a unique key shared only with the user during generation of the blockchain user account in the initialization process. The utilization of the private key for modification of the privacy settings is further described at step 323.

At 307, the plurality of privacy settings may be provided initially, by use of the electronic device 103, to the user. In accordance with an embodiment, the processor 201, as part of the initialization process, may initially provide the plurality of privacy settings to the user. The plurality of privacy settings may be associated with the permission of usage of the user data of the user for the electronic device 103 associated with the user. For example, a first privacy setting of the plurality of privacy settings may correspond to a location of the user. The first privacy setting may indicate if the permission to record the location of the user is approved or rejected. In another example, a second privacy setting of the plurality of privacy settings may correspond to an audio of the user. The second privacy setting may indicate if the permission to record the audio of the user is approved or rejected. Similarly, one or more privacy settings of the plurality of privacy settings may correspond to sharing of the user data with a third-party. The processor 201 may provide the plurality of privacy settings to the user during initialization and setup of the electronic device 103.

The plurality of privacy settings may be provided initially, for example, on a display associated with the electronic device 103. In an exemplary scenario, the electronic device 103 may be a smartphone with a display. The plurality of privacy settings may be displayed on the display of the smartphone. In an embodiment, the processor 201 may initially provide the plurality of privacy settings in form of an audio output. For example, the plurality of privacy settings may be read-out for the user.

At 309, the plurality of privacy settings may be set up, based on the one or more privacy settings of the plurality of privacy settings initially accepted by the user. In accordance with an embodiment, the processor 201 may be configured to set up of the plurality of privacy settings based on the one or more privacy settings of the plurality of privacy settings initially accepted by the user. For example, the first privacy setting associated with the location of the user may be accepted by the user. In such a case, the location of the user may be recorded by the electronic device 103. In another example, the second privacy setting associated with the audio of the user may be rejected by the user. In such a case, the processor 201 may not provide the permission to the electronic device 103 to record the audio of the user.

In some embodiments, the processor 201 may receive a touch input corresponding to the acceptance or rejection by the user. For example, a set of selections associated with each privacy setting may be displayed on the display of the electronic device 103. A first selection of the set of selections may correspond to “allowance” of the privacy setting. A second selection of the set of selections may correspond to “rejection” of the privacy setting. For example, based on a preference of the user, the touch input corresponding to “allowance” or “rejection” may be received by the processor 201. In some embodiments, an audio input may be received by the processor 201. For example, the word “accept” or “reject” may be received as the audio input from the user to accept or reject the plurality of privacy settings. Based on the one or more privacy settings of the plurality of privacy settings initially accepted by the user, the processor 201 may set up the plurality of privacy settings.

At 311, the plurality of assets 107a associated with the plurality of privacy settings may be generated. In accordance with an embodiment, the processor 201 may be configured to generate the plurality of assets 107a based on the set up of the plurality of privacy settings. For example, each asset of the plurality of assets 107a may be associated with an accepted privacy setting of the plurality of privacy settings. The presence of the plurality of assets 107a in the blockchain user account may indicate the corresponding privacy settings accepted by the user. In an embodiment, the rejection of the privacy setting by the user may result in deletion of the corresponding asset of the plurality of assets 107a from the blockchain user account.

In accordance with an embodiment, the plurality of assets 107a may be associated with at least one of a remote control of the electronic device 103, a set of anonymous data acquired from one or more sensors associated with the electronic device 103, a set of personal data associated with the user acquired from the one or more sensors, or backup data required in a situation of privacy breach of the user data. The asset associated with the remote control of the electronic device 103 may be utilized for control of the electronic device 103 via the cloud-based service 105. For example, the electronic device 103 may be the interactive robot. The presence of the asset associated with the remote control of the electronic device 103 may be utilized for the remote control of the interactive robot. The asset associated with the set of anonymous data acquired from the one or more sensors associated with the electronic device 103 may be utilized to collect anonymous data associated with the user for various applications, such as gameplay. The asset associated with the set of personal data associated with the user acquired from the one or more sensors may be utilized for recording of the data such as audio information of the user for a personalized experience. The asset associated with the backup data required in a situation of privacy breach of the user data may be utilized in a case the web address or a uniform resource locator (URL) of the cloud-based service 105 has been compromised, or in a situation when the URL may be untrusted.

Each asset may include at least a metadata hash value of the privacy setting and the web address of the cloud-based service 105. The metadata hash value may be a unique value of the permission of the privacy setting provided by the user. The web address or the URL or an internet protocol (IP) address of the cloud-based service 105 may be the permissioned address for the user data on the cloud-based service 105. The URL of the cloud-based service 105 may be utilized by the electronic device 103 to access online features. Furthermore, a name field in the asset may reflect the corresponding privacy setting. For example, the name field may depict “HR_RC” for the asset associated with the remote control of the electronic device 103. The fields such as the metadata hash value, the URL and the name field may be immutable by a setting administrator. The URL of the cloud-based service 105 may be set to a zero address by the processor 201, thus, the processor 201 may ensure that the URL is unable to be tampered with in future.

In accordance with an embodiment, the plurality of assets 107a may be generated in accordance with compliance with one or more of a General Data Protection Regulation (GDPR) policy, a Children's Online Privacy Protection Rule (COPPA), or a Health Insurance Portability and Accountability Act (HIPAA). Data protection policies, such as the GDPR, the COPPA and the HIPPA may be implemented to safeguard the privacy of the user data. The GDPR policy ensures regulation on the sharing of the personal data, such as the user data associated with the user. The COPPA may specifically deal with the protection of the user data associated with the user below an age of 13 years. The HIPPA may specifically deal with the protection of the sensitive health information in the user data associated with the user.

At 313, the generated plurality of assets 107a may be transferred to the blockchain user account associated with the user. The generated plurality of assets 107a may be transferred to the blockchain user account as part of the initialization process. In accordance with an embodiment, the processor 201 may be configured to transfer the plurality of assets 107a to the blockchain user account associated with the user. The generated plurality of assets 107a stored in the blockchain user account may indicate that the permission of the corresponding privacy setting has been given by the user.

At 315, after the electronic device 103 may be switched on, the generated plurality of assets and the user account address associated with the generated blockchain user account may be fetched from the blockchain user account. In accordance with an embodiment, the processor 201 may be configured to fetch the plurality of assets and the user account address, after the electronic device 103 may be switched on. Once the initialization process may be complete, and the plurality of assets 107a may be stored in the blockchain user account, the user may require utilizing the electronic device 103. In an embodiment, the processor 201, after completion of the initialization process, may store details of a Wi-Fi network. Thus, the processor 201 may fetch the plurality of assets and the user account address from the blockchain user account.

The processor 201 may further transfer the generated plurality of assets 107a and the user account address to the electronic device 103. The generated plurality of assets 107a may be utilized by the user to approve or reject the plurality of privacy settings. The user account address may be utilized by the user to access the generated plurality of assets 107a from the blockchain user account. The user account address may further be utilized by the user to view details such as currency in the blockchain wallet associated with the blockchain user account.

Every time the electronic device 103 may be switched on, the processor 201 may further check the plurality of assets 107a present on the blockchain user account in order to determine the plurality of privacy settings and the URL for the online features of the electronic device 103. The processor 201 may further filter out the plurality of assets 107a not created by the other entities.

At 317, the set of selections associated with each asset may be provided to the user, by use of the electronic device 103. In accordance with an embodiment, the processor 201 may be configured to provide the set of selections associated with each asset to the user, by use of the electronic device 103. Each selection of the set of selections may correspond to one of acceptance of the privacy setting, rejection of the privacy setting or modification of the privacy setting. In an exemplary scenario, the user may require checking the plurality of privacy settings. For example, the user may require the electronic device 103 to record the location of the user only while using the electronic device 103. In such a case, the set of selections may be utilized by the user.

At 319, the one or more inputs may be received from the user based on the set of selections provided to the user. In accordance with an embodiment, the processor 201 may be configured to receive the one or more inputs from the user based on the set of selections provided to the user. For example, the one or more inputs may be in form of the touch input or the audio input. In an exemplary scenario, the set of selections corresponding to the privacy setting associated with the location may include a first selection as “access location every time”, a second selection as “access location only while using the device” and a third selection as “do not access location”. The processor 201 may receive the input corresponding to the second selection as “access location only while using the device”.

At 321, the one or more privacy settings of the plurality of privacy settings may be modified based on the received one or more inputs from the user. In accordance with an embodiment, the processor 201 may be configured to modify the one or more privacy settings of the plurality of privacy settings based on the received one or more inputs from the user. Based on the preference of the user, the processor 201 may modify the one or more privacy settings.

In In accordance with an embodiment, the modified one or more privacy settings are utilized for at least one of: granting one or permissions of the usage of the user data, revoking of one or permissions of the usage of the user data, or selection of a different cloud-based service. For example, the processor 201 may modify the location setting from “access location every time” to “access location only while using the device”, based on the input received from the user. In such a case, the permission to access location every time may be revoked by the processor 201. Furthermore, the different cloud-based service 105 may be selected by the user. The permission to transmit the user data to the cloud-based service 105 may be revoked by the user, in case the user may require to use a different cloud-based service. Thus, the control of the user data may fully be in hands of the user. The user may modify any privacy settings without a need to contact any system administrator.

At 323, the web address of the cloud-based service 105 may be verified. In accordance with an embodiment, the processor 201 may be configured to verify the web address of the cloud-based service 105, before transmission of the user data of the user to the web address of the cloud-based service 105. The web address of the cloud-based service 105 may be specified in the plurality of assets 107a. The web address may be verified by the processor 201 such as to ensure that the user data may be transferred to a trusted source.

At 325, the user data of the user may be transmitted to the web address of the cloud-based service 105, based on the modified one or more privacy settings of the plurality of privacy settings. In accordance with an embodiment, the processor 201 may be configured to transmit the user data of the user to the web address of the cloud-based service 105, based on the modified one or more privacy settings of the plurality of privacy settings. For example, the online features of the electronic device 103 may need to be accessed. In such a case, the user data may be transmitted to the web address of the cloud-based service 105 to access the online features of the electronic device 103.

In accordance with an embodiment, the processor 201 may be configured to transmit the user data from the electronic device 103 to the web address of the cloud-based service 105, based on the generated cryptographic key pair. The private key of the cryptographic key pair accessible only to the user of the electronic device 103 may be required to transmit the user data from the electronic device 103 to the web address of the cloud-based service 105. Thus, the processor 201 may ensure minimization of the data breach.

In accordance with an embodiment, the processor 201 may be configured to utilize Hypertext Transfer Protocol Secure (HTTPS) to transmit the user data from the electronic device 103 to the web address of the cloud-based service 105. The HTTPS may be utilized to securely transmit the user data from the electronic device 103 to the web address of the cloud-based service 105. Such utilization of the HTTPS may ensure utmost protection of the user data.

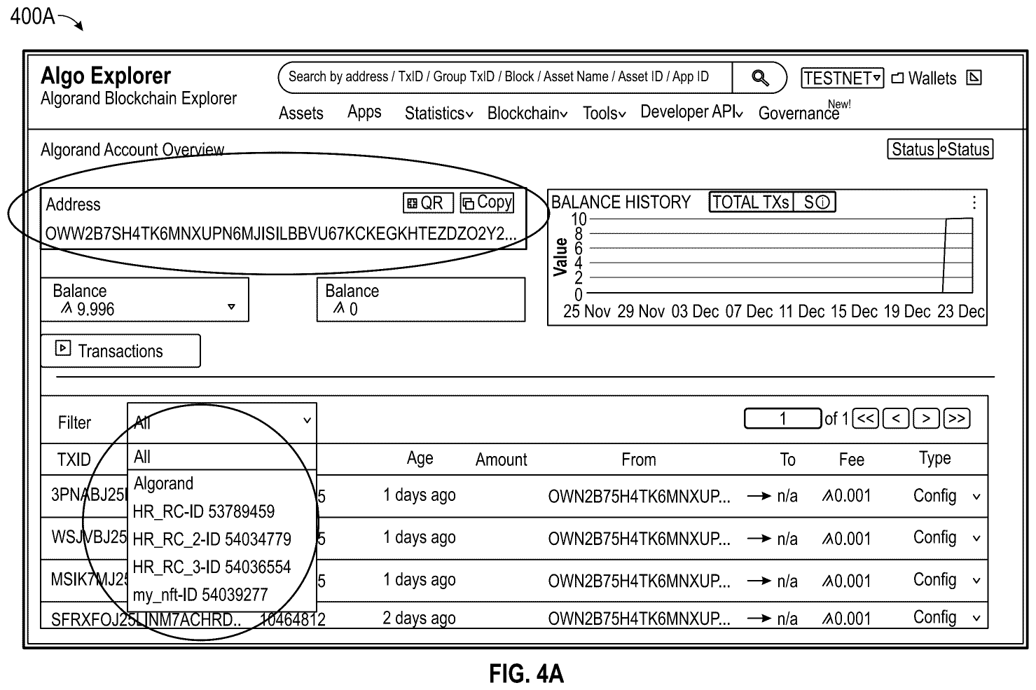

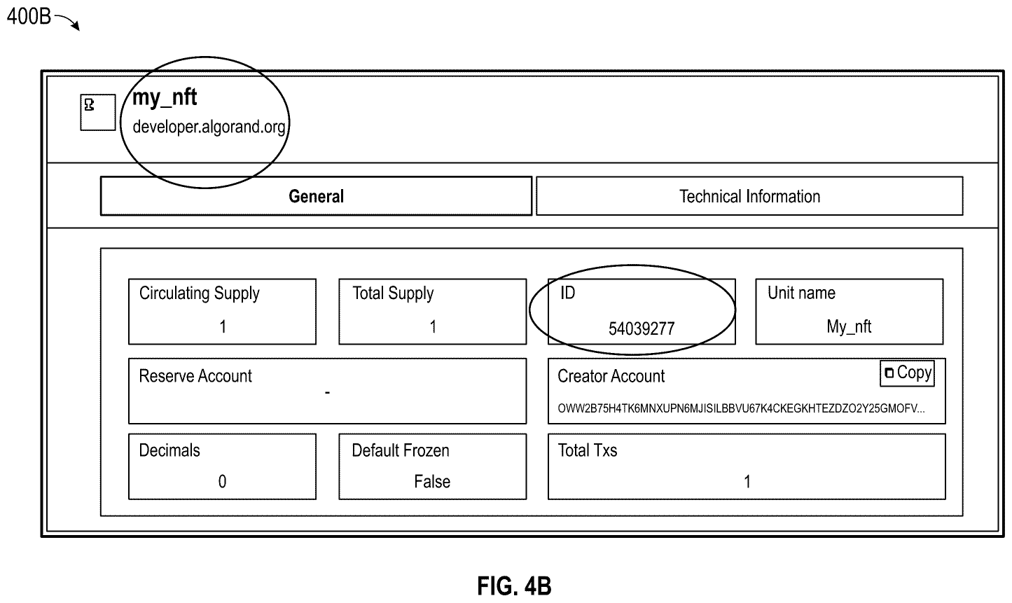

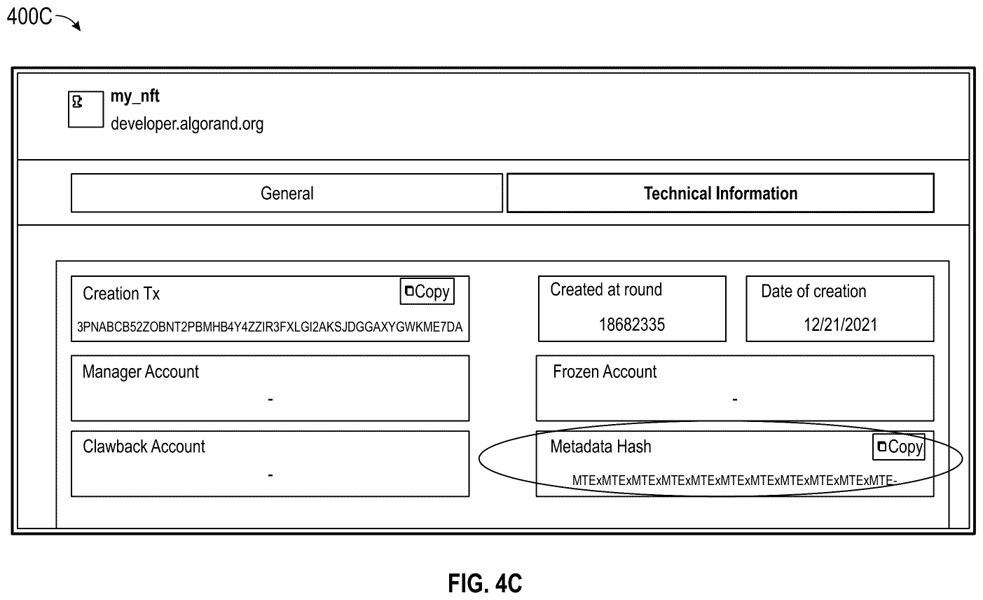

FIG. 4A is a first user interface (UI) 400A that depicts a blockchain user account, in accordance with an embodiment. FIG. 4A is described in conjunction from elements of FIGS. 1, 2 and 3.

The blockchain user account may be viewed by the user via an explorer tool. For example, the explorer tool may be “Algorand” explorer tool. The UI 400A shows the public key associated with the blockchain user account. An exemplary public key may be “OWW2B7SH4TK6MNXUPN6MJISILBBVU67K4CKEGKHTEZDZO2Y25GMQFV5LD M”. The first UI 400A may further depict a balance in the blockchain wallet associated with the blockchain user account. The first UI 400A may further depict the generated plurality of assets 107a with their unique identifiers in the blockchain user account. For example, a first asset may be “HR_RC-ID 5379459”. A second asset may be “HR_RC_2-ID 54034779”. A third asset may be “HR_RC_3-ID 54036554”. A fourth asset may be “my_nft-ID 54039277”.

FIG. 4B is a second UI 400B that depicts general information of an asset, in accordance with an embodiment. FIG. 4B is described in conjunction from elements of FIGS. 1, 2, 3 and 4A.

The second UI 400B may depict the general information of the fourth asset “my_nft-ID 54039277”. The general information may include the unique identifier of the asset such as “54039277”. The general information may further include the creator address number that is the public key, and the like.

FIG. 4C is a third UI 400C that depicts technical information of the asset, in accordance with an embodiment. FIG. 4C is described in conjunction from elements of FIGS. 1, 2, 3, 4A and 4B.

The third UI 400C may depict the technical information of the fourth asset “my_nft-ID 54039277”. The technical information may include the metadata hash associated with the asset. The technical information may further include a creation transaction detail, a date of creation of the asset, and the like. The first UI 400A, the second UI 400B and the third UI 400C may be utilized by the user to for example, view and delete the unrequired assets corresponding to the privacy settings not required by the user.

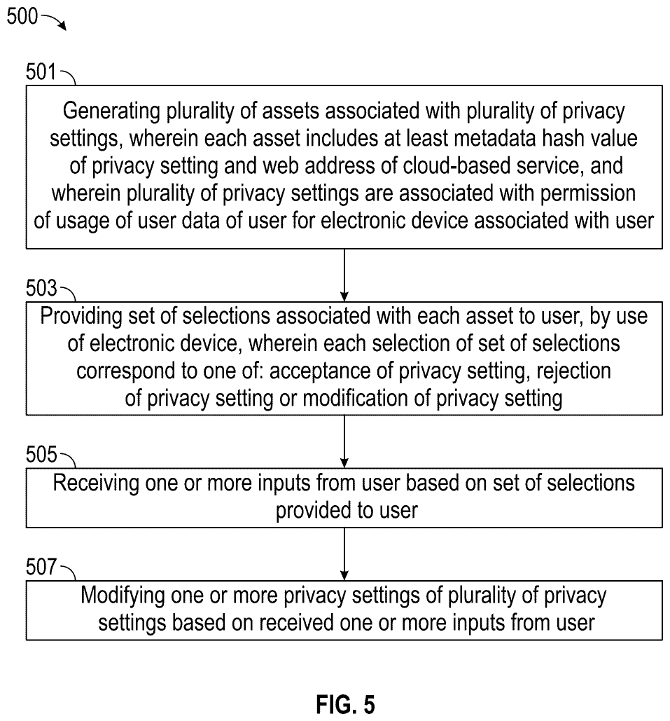

FIG. 5 is a flowchart illustrating a method of data privacy control, in accordance with an embodiment. The method may include various steps performed by the system 101 in order to perform data privacy control. It will be understood that each block of the flow diagram of the method 500 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 203 of the system 101, employing an embodiment of the present invention and executed by a processor 201. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

At step 501, the plurality of assets 107a associated with the plurality of privacy settings may be generated. Each asset may include at least the metadata hash value of the privacy setting and the web address of the cloud-based service. The plurality of privacy settings ma be associated with the permission of usage of the user data of the user for the electronic device 103 associated with the user. In accordance with an embodiment, the processor 201 may be configured to generate the plurality of assets 107a associated with the plurality of privacy settings.

In some embodiments, the processor 201 may be configured to perform the initialization process to generate the plurality of assets 107a. The initialization process may include generation of the blockchain user account, initially providing the plurality of privacy settings to the user, setting up the plurality of privacy settings and generating of the plurality of assets 107a based on the set up of the plurality of privacy settings.

At step 503, the set of selections associated with each asset may be provided to the user, by use of the electronic device 103. Each selection of the set of selections may correspond to one of the acceptance of the privacy setting, the rejection of the privacy setting or the modification of the privacy setting. In accordance with an embodiment, the processor 201 may be configured to provide the set of selections associated with each asset to the user. For example, the processor 201 may display the set of selections on the electronic device 103 to the user.

At step 505, the one or more inputs may be received from the user based on the set of selections provided to the user. In accordance with an embodiment, the processor 201 may be configured to receive the one or more inputs from the user based on the set of selections provided to the user. For example, an input may correspond to acceptance of the privacy setting associated with the audio of the user.

At step 507, the one or more privacy settings of the plurality of privacy settings may be modified based on the received one or more inputs from the user. In accordance with an embodiment, the processor 201 may be configured to modify the one or more privacy settings of the plurality of privacy settings based on the received one or more inputs from the user. The modified one or more privacy settings may enable the required user data to be transmitted to the cloud-based service 105.

In some embodiments, the processor 201 may be configured to generate the blockchain user account associated with the user. The blockchain user account may be generated on the blockchain network. The generated blockchain user account may be associated with the user account address. The processor 201 may further initially provide the plurality of privacy settings, by use of the electronic device 103, to the user. Based on one or more privacy settings of the plurality of privacy settings initially accepted by the user, the processor 201 may set up of the plurality of privacy settings. The processor 201 may further generate of the plurality of assets 107a based on the set up of the plurality of privacy settings. The processor 201 may transfer the generated plurality of assets to the blockchain user account associated with the user.

In some embodiments, the processor 201 may be configured to, after the electronic device 103 may be switched on, fetch the generated plurality of assets 107a and the user account address associated with the generated blockchain user account from the blockchain user account. The processor 201 may transfer the generated plurality of assets 107a and the user account address to the electronic device 103. The processor 201 may further provide the set of selections associated with the generated plurality of assets to the user, by use of the electronic device 103.

In some embodiments, the generated blockchain user account may be associated with the cryptographic key pair.

In some embodiments, the cryptographic key pair may include the public key and the private key. The public key may be stored in the memory and the electronic device 103. The private key may be transmitted to the electronic device 103 associated with the user.

In some embodiments, the processor 201 may be configured to transmit the user data of the user to the web address of the cloud-based service 105, based on the modified one or more privacy settings of the plurality of privacy settings.

In some embodiments, the processor 201 may be configured to verify the web address of the cloud-based service 105, before transmission of the user data of the user to the web address of the cloud-based service 105.

In some embodiments, the processor 201 may be configured to utilize the Hypertext Transfer Protocol Secure (HTTPS) to transmit the user data from the electronic device 103 to the web address of the cloud-based service 105.

In some embodiments, the processor 201 may be configured to generate the identifier associated with the electronic device 103. The processor 201 may further generate the cryptographic key pair associated with the blockchain user account, based on the generated identifier associated with the electronic device 103. Based on the generated cryptographic key pair, the processor 201 may transmit the user data from the electronic device 103 to the web address of the cloud-based service 105.

In some embodiments, the plurality of assets ma be associated with at least one of the remote control of the electronic device 103, the set of anonymous data acquired from one or more sensors associated with the electronic device 103, the set of personal data associated with the user acquired from the one or more sensors, or the backup data required in the situation of privacy breach of the user data.

In some embodiments, the processor 201 may be configured to generate the plurality of assets in accordance with compliance with one or more of the General Data Protection Regulation (GDPR) policy, the Children's Online Privacy Protection Rule (COPPA), or the Health Insurance Portability and Accountability Act (HIPAA).

In some embodiments, the modified one or more privacy settings may be utilized for at least one of granting one or permissions of the usage of the user data, revoking of one or permissions of the usage of the user data, or selection of the different cloud-based service.

As will be also appreciated, the above-described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

The disclosed methods and systems may be implemented on a conventional or a general-purpose computer system, such as a personal computer (PC) or server computer. It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A system for data privacy control, the system comprising:
a processor;
a memory communicatively coupled to the processor, wherein the memory stores a plurality of processor-executable instructions which upon execution by the processor cause the processor to:
generate a plurality of assets associated with a plurality of privacy settings, wherein each asset includes at least a metadata hash value of a corresponding privacy setting and a web address of a cloud-based service, and wherein the plurality of privacy settings are associated with a permission of usage of user data of a user for an electronic device associated with the user;
provide a set of selections associated with each asset to a user, by use of the electronic device, wherein each selection of the set of selections correspond to one of: acceptance of the privacy setting, rejection of the privacy setting or modification of the privacy setting;
receive one or more inputs from the user based on the set of selections provided to the user; and
modify one or more privacy settings of the plurality of privacy settings based on the received one or more inputs from the user.

2. The system of claim 1, wherein the plurality of processor-executable instructions, upon execution by the processor, further cause the processor to perform an initialization process that comprises:
generating of a blockchain user account associated with the user, wherein the blockchain user account is generated on a blockchain network, and wherein the generated blockchain user account is associated with a user account address;
providing the plurality of privacy settings, initially, by use of the electronic device, to the user;
setting up of the plurality of privacy settings based on one or more privacy settings of the plurality of privacy settings initially accepted by the user; and
generation of the plurality of assets based on the set up of the plurality of privacy settings; and
transfer the generated plurality of assets to the blockchain user account associated with the user.

3. The system of claim 2, wherein the plurality of processor-executable instructions, upon execution by the processor, further cause the processor to:
after the electronic device is switched on, fetch the generated plurality of assets and the user account address associated with the generated blockchain user account from the blockchain user account; and
transfer the generated plurality of assets and the user account address to the electronic device; and
provide the set of selections associated with the generated plurality of assets to the user, by use of the electronic device.

4. The system of claim 2, wherein the generated blockchain user account is associated with a cryptographic key pair.

5. The system of claim 2, wherein the cryptographic key pair includes a public key and a private key, wherein
the public key is stored in the memory and the electronic device, and
the private key is transmitted to the electronic device associated with the user.

6. The system of claim 1, wherein the plurality of processor-executable instructions, upon execution by the processor, further cause the processor to transmit the user data of the user to the web address of the cloud-based service, based on the modified one or more privacy settings of the plurality of privacy settings.

7. The system of claim 6, wherein the plurality of processor-executable instructions, upon execution by the processor, further cause the processor to verify the web address of the cloud-based service, before transmission of the user data of the user to the web address of the cloud-based service.

8. The system of claim 6, wherein the plurality of processor-executable instructions, upon execution by the processor, further cause the processor to utilize Hypertext Transfer Protocol Secure (HTTPS) to transmit the user data from the electronic device to the web address of the cloud-based service.

9. The system of claim 6, wherein the plurality of processor-executable instructions, upon execution by the processor, further cause the processor to:
generate an identifier associated with the electronic device;
generate a cryptographic key pair associated with the blockchain user account, based on the generated identifier associated with the electronic device; and
transmit the user data from the electronic device to the web address of the cloud-based service, based on the generated cryptographic key pair.

10. The system of claim 1, wherein the plurality of assets are associated with at least one of: a remote control of the electronic device, a set of anonymous data acquired from one or more sensors associated with the electronic device, a set of personal data associated with the user acquired from the one or more sensors, or backup data required in a situation of privacy breach of the user data.

11. The system of claim 1, wherein the plurality of processor-executable instructions, upon execution by the processor, further cause the processor to generate the plurality of assets in accordance with compliance with one or more of: a General Data Protection Regulation (GDPR) policy, a Children's Online Privacy Protection Rule (COPPA), or a Health Insurance Portability and Accountability Act (HIPAA).

12. The system of claim 1, wherein the modified one or more privacy settings are utilized for at least one of: granting one or permissions of the usage of the user data, revoking of one or permissions of the usage of the user data, or selection of a different cloud-based service.

13. A method of data privacy control comprising:
generating a plurality of assets associated with a plurality of privacy settings, wherein each asset includes at least a metadata hash value of the privacy setting and a web address of a cloud-based service, and wherein the plurality of privacy settings are associated with a permission of usage of user data of a user for an electronic device associated with the user;
providing a set of selections associated with each asset to a user, by use of the electronic device, wherein each selection of the set of selections correspond to one of: acceptance of the privacy setting, rejection of the privacy setting or modification of the privacy setting;
receiving one or more inputs from the user based on the set of selections provided to the user; and
modifying one or more privacy settings of the plurality of privacy settings based on the received one or more inputs from the user.

14. The method of claim 1, further comprising performing of an initialization process that includes:
generating a blockchain user account associated with the user, wherein the blockchain user account is generated on a blockchain network, and wherein the generated blockchain user account is associated with a user account address;
initially providing the plurality of privacy settings, by use of the electronic device, to the user;
setting up the plurality of privacy settings based on one or more privacy settings of the plurality of privacy settings accepted by the user; and
generating of the plurality of assets based on the set up of the plurality of privacy settings; and
transferring the generated plurality of assets to the blockchain user account associated with the user.

15. The method of claim 1, further comprising:
after the electronic device is switched on, fetching the generated plurality of assets and the user account address associated with the generated blockchain user account from the blockchain user account; and
transferring the generated plurality of assets and the user account address to the electronic device; and
providing the set of selections associated with the generated plurality of assets to the user, by use of the electronic device.

16. The method of claim 15, wherein the generated blockchain user account is associated with a cryptographic key pair.

17. The method of claim 15, wherein the cryptographic key pair includes a public key and a private key, wherein
the public key is stored in the memory and the electronic device, and
the private key is transmitted to the electronic device associated with the user.

18. The method of claim 15, further comprising transmitting of the user data of the user to the web address of the cloud-based service, based on the modified one or more privacy settings of the plurality of privacy settings.

19. The method of claim 15, further comprising verifying the web address of the cloud-based service, before transmission of the user data of the user to the web address of the cloud-based service.

20. A non-transitory computer-readable medium storing computer-executable instructions for performing interaction, the computer-executable instructions configured for:
generating a plurality of assets associated with a plurality of privacy settings, wherein each asset includes at least a metadata hash value of the privacy setting and a web address of a cloud-based service, and wherein the plurality of privacy settings are associated with a permission of usage of user data of a user for an electronic device associated with the user;
providing a set of selections associated with each asset to a user, by use of the electronic device, wherein each selection of the set of selections correspond to one of: acceptance of the privacy setting, rejection of the privacy setting or modification of the privacy setting;
receiving one or more inputs from the user based on the set of selections provided to the user; and
modifying one or more privacy settings of the plurality of privacy settings based on the received one or more inputs from the user.
